(19) United States
(12) Patent Application Publication
(10) Pub. No.: US 2003/0110371 A1
(43) Pub. Date: Jun. 12, 2003

(54) Methods and apparatus for storing, updating, transporting, and launching personalized computer settings and applications

(76) Inventors: Yongzhi Yang, Irvine, CA (US); Douglas Glen, Manhattan Beach, CA (US); Luke Yi, Orange, CA (US); Andrew Rifkin, Los Angeles, CA (US)

Correspondence Address: Yongzhi Yang, 525 Santa Maria Dr., Irvine, CA, 92606, US

(21) Appl. No.: 10/014,739

(22) Filed: Dec. 8, 2001

(51) Int. Cl. G06F 15/16

(52) U.S. Cl. 713/100

(57) ABSTRACT

A method and an apparatus for transporting user-specific information from one personal computer to another are described. One version of the system utilizes pocket-sized USB flash memory devices (USB Drives). When the USB Drive is connected to a first computer, typically the user's everyday computer, user-specific information, such as email account settings, address book, sent and received emails, etc. is captured on the USB Drive. When the USB Drive is plugged into a second computer, typically a publicly-accessible or borrowed computer, and an application is launched, such as Outlook, user-specific information is temporarily loaded from the USB Drive into the Outlook application. Consequently, the user is able to work on the borrowed computer as if he is working on his everyday computer at home or in the office. Updated information, such as new emails received, is automatically saved to the USB Drive for subsequent transport to the everyday computer.

### BACKGROUND OF THE INVENTION

In recent years, personal computers (PCs) have become everyday necessities for people conducting business and managing their lives, whether at the office, at home, or on the road. Many people have come to depend on their personal computers for communicating with others, keeping appointments, managing finances, learning new skills, and doing their jobs.

Many people now use more than one computer to conduct their everyday business. It is common for people to have an office computer and a home computer. It is becoming common for people to use publicly-accessible computers in airports, hotels, school laboratories, business centers and other such locations. The most commonly-used PC applications, such as email, word processing, and personal finance, were not designed for use by people who frequently switch computers. For example, frequent travelers who use Microsoft Outlook to manage email and appointments may receive email on one PC, but may wish to respond later from another PC. Microsoft Outlook does not allow users to conveniently transport such “pending emails” from one machine to another, nor to transport files to create a master database of all emails received and sent on the user's primary machine. Similarly, Microsoft Word does not offer a simple facility for storing a user's formatting preferences, custom templates, work-in-process, and work that has been recently modified, on a device that automatically makes such formatting preferences, custom templates, and work-in-process files available on any PC which the user chooses to utilize.

The traditional method has been for the user to save or “backup” computer files onto a storage device, such as a floppy disk, a removable hard disk or a pocket-sized USB flash memory device (USB Drive), and then transport the files between different computers. This method works fairly well with applications such as Microsoft Word, which allow for easy backup to floppy disks and other removable storage. The method is more troublesome with applications like Microsoft Outlook, which do not have well-known and straightforward procedures for updating one computer's data from data loaded onto a floppy disk from a different PC. In some cases, even if a user knows what information he wants to transport to another computer, he may not know which file to transport. For example, if a user receives new emails in his office computer and wants to reply to these emails later from his home computer, he may not be able to identify the database file (a “dbx” file) that contains these emails. Therefore, he would not be able to conveniently transport these emails to his home computer in order to reply to them later.

Various methods have been used in the prior art for transporting and updating files between computers. In one method, associations between files in two computers are created. The associated files are synchronized when the two computers are connected and when the synchronization process is initiated by the user. These types of methods allow users to synchronize files in two computers if the two computers can be directly linked, for example through network or other connections, including wired or wireless connections. For example, a user may travel with his laptop computer. When he comes back to his office, he can connect his laptop computer with his desktop computer and synchronize the files in the two computers. However, if the user uses a desktop computer at the office and another desktop computer at home, it will be very hard for him to synchronize files in the two computers using this method. Also the method does not provide a way for users to synchronize data generated or accessed on publicly-accessible computers.

In sum, although there exist various methods for synchronizing data between PCs, there exists no simple, convenient method for transforming a temporarily used PC into a “look alike-work alike” clone of one's everyday PC. The method and apparatus described in this invention disclosure enable people to work on virtually any PC as if it were their everyday PC, complete with familiar look and feel, configuration preferences, email options, and application data. In addition, the method and apparatus described in this invention disclosure enable people to easily transport work-in-process data from one PC to another, regardless of whether the PC is theirs, their employer's, or a publicly-accessible device.

### BRIEF SUMMARY OF THE INVENTION

The present invention provides a solution that allows a user to connect a portable storage device (PSD) to his/her everyday computer (which is defined as the PC or PCs used most often by the user), automatically store user-specific configurations, settings, and application data to the PSD, transport the information to a guest PC (which is defined as a PC that is not the user's everyday PC, such as a PC for public access in an airport or hotel), and load the user-specific configurations, settings, and application data to the guest PC operating environment, and into the specific applications the user decides to launch. The operating system and applications automatically read from and write to the PSD, enabling any file created, received or modified by the user to be automatically stored to the PSD. From the user's perspective, the guest PC will operate just like his/her everyday PC, with the same background graphics, default settings, formatting preferences, email settings, browser settings, and so forth. When an application is launched, the application will be configured as on the user's everyday machine, with the same everyday data available, such as email address books, financial accounts, and so forth. When the user ends a session, he/she will be able to transport updated databases, settings, and configurations, as well as the files currently being created and updated, in the PSD. The present invention also provides a way to automatically backup selected user-specific information associated with user-selected applications to a PSD and synchronize selected information in two different PCs.

Generally described, the present invention involves a portable storage device (PSD) which contains an application program (PSD Program) that implements the method described in the present invention. When the PSD is connected to a PC, the PSD Program is launched, presenting a menu on the computer screen. The menu choices include launching applications and synchronizing personal information stored in the PSD and in the PC. For example, if a PSD is connected to the user's everyday PC for the first time and the user chooses to synchronize Outlook Express related information, then user's personal Outlook Express configuration, including STMP and POP server settings, user names, passwords, address book, and email folders will be retrieved from the PC and stored in the PSD. When the user activates his/her PSD device on a guest PC and launches Outlook Express, Outlook Express will be available with all of the user's custom settings, including email account settings, STMP and POP server settings, address book and email folders. Upon completion of the session on the guest PC, the user's received emails, sent emails, and email attachments will be automatically stored in the PSD. When the user later comes back to his/her everyday PC and chooses to synchronize personal information, the PC will be updated with the newly received or modified information and settings stored in the PSD.

In one embodiment of the present invention, a commercially available pocket-sized flash memory storage device with a USB interface (USB Drive) is utilized as the portable storage device (PSD). Several such currently-available devices are about two inches long and three-quarters of an inch wide, and can be easily carried around, for example, on a key chain. No cable or external power supply is needed for such devices.

In a second embodiment, a commercially available pocket-sized removable hard disk with a USB interface is utilized as the portable storage device (PSD). No external power supply is needed for this device.

### BRIEF DESCRIPTION OF THE DRAWINGS

FIG. 1 is a logical flow diagram describing the initialization component of the method of the present invention.

FIG. 2 is a logical flow diagram describing the synchronization component of the method of the present invention.

FIG. 3 is a logical flow diagram describing the MS Office application launching component of the method of the present invention.

FIG. 4 is a logical flow diagram describing the Outlook Express application launching component of the method of the present invention.

### DETAILED DESCRIPTION OF THE INVENTION

This invention will be described with a specific embodiment, and with a specific reference to certain operating system and set of applications. However, this invention should be also understood as applicable to other operating systems, whether with graphical user interface or character based user interface, as well as with virtually all other PC applications. It should also be understood that the invention is applicable to non-PC devices, including without limitation video game machines, automobiles, and medical devices. It should also be understood that certain details in the following descriptions, such as the names of the menu items, or the wording of the messages displayed on the screen, only serves as examples and can be changed in the various implementations and instantiations of the invention.

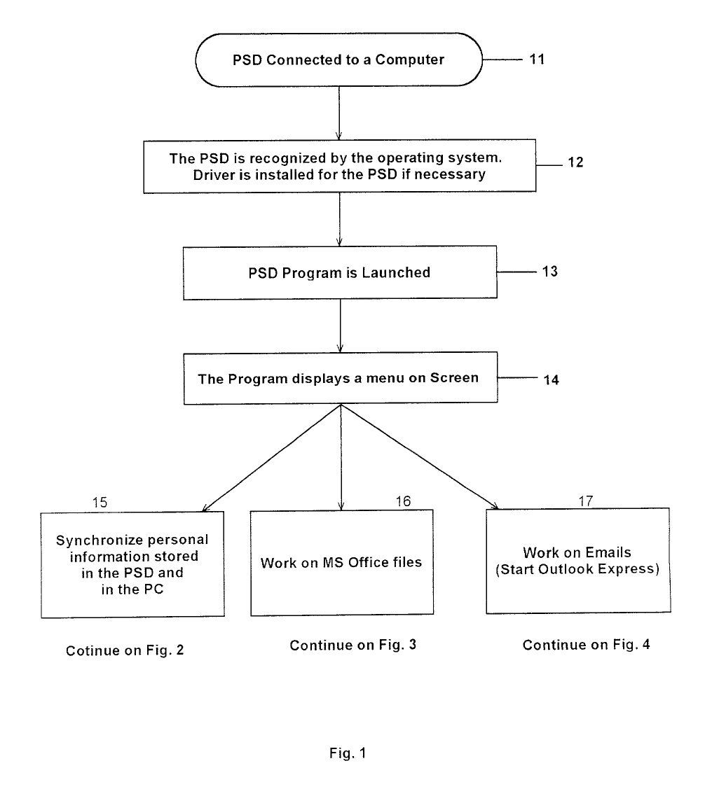

FIG. 1 depicts the initialization process. In step 11, a PSD is connected to a communications port of a PC. For example, if the PSD is a pocket-sized USB flash memory device, it is plugged into the USB port of the PC. In step 12, as soon as the PSD is connected to the PC, the PC recognizes the device. If it is the first time this type of PSD is connected to this PC, a driver installation process will be started and an appropriate driver will be installed. Commercially available portable storage devices appropriate for use as a PSD, such as the pocket-sized USB flash memory device, already have the capability of being recognized by the PC as soon as they are connected, and they generally ship with the appropriate device drivers to enable the installation of the PSD application described by this invention. In step 13, the PSD Program is launched. The program may be launched automatically, in case the portable storage device supports “autorun” programs, that is, which allow the program to be launched automatically once the device is connected to the PC. If the portable storage device does support “autorun”, simple user interventions, such as clicking on icons, will usually be necessary in order to launch the PSD Program. In step 14, the PSD Program launches a menu box on the screen of the PC. From the menu items, the user can choose “Synchronize personal information stored in the PSD and in the PC” (step 15); or “Work on MS Office files” (step 16); or “Work on Emails (Start Outlook Express)” (step 17).

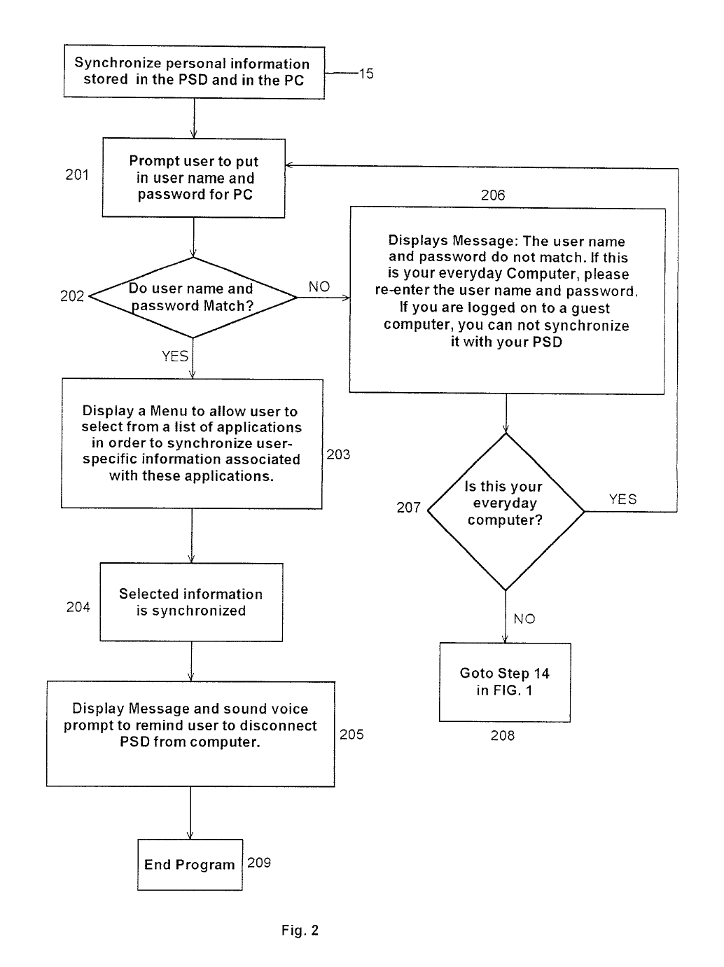

FIG. 2 depicts the synchronization process. Once the user selects “Synchronize personal information stored in the PSD and in the PC” in step 15, a prompt will be displayed to ask the user to enter his/her user name and password for the PC (step 201). This procedure provides additional protection against inadvertent loading of the user's personal data on, for example, a publicly-accessible PC. Step 202 compares the user name and password against the user name and password for the PC. If the user name and password entered do not match the user name and password for the PC, a message will be displayed in step 206 to tell the user that either he entered wrong user name or password, or this is not his/her everyday computer and he/she is not allowed to perform synchronization. In Step 207, the user is asked whether this is his/her everyday PC. If the answer is yes, he/she is directed to go back to step 201 to enter his/her user name and password again. If the answer is no, he/she is directed to go back to step 14 so he/she can choose other items from the menu. Going back to decisional step 202, if the answer is yes, a menu will be displayed in step 203, allowing the user to synchronize information associated with selected applications. For example, if the user selects the email application, then all his/her personal information associated with the email application, including email account settings, email configuration, address book, email folders such as inbox and sent items, and attachments, will be synchronized. Note that synchronizing personal information means synchronizing all the files containing the information. These may include Windows system files, such as the one containing user account information. The synchronization is carried out in step 204. In this step, files containing selected information stored in the PC and in the PSD are compared. If a file is found in PC but not in PSD, it is, at the user's choice, copied to PSD or deleted from the PC. If a file is found in the PSD but not in the PC, it is, at the user's choice, copied to the PC or deleted from the PSD. If a file is found to exist both in the PC and in the PSD, then the newer version will replace the older version. In one of the embodiments of the present invention, if a file is found to be in both PC and PSD and both are “new,” that is, both are changed since the last synchronization, then the two files are merged. In the merger process, new information found in one file, such as a newly received email contained in the file inbox.dbx in the PC, will be inserted into the file with the same name stored in the PSD, and vice versa. Note that the synchronization process is not described in detail here since it has been described in prior arts. Once the step 204 is completed, a message is displayed with voice prompt in step 205 to remind the user to disconnect the PSD from the PC. The program is ended in step 209. In one of the embodiments of the present invention, the user is prompted at various times to consider deleting older and/or potentially unnecessary data from the PSD to conserve storage space and to make space for new data.

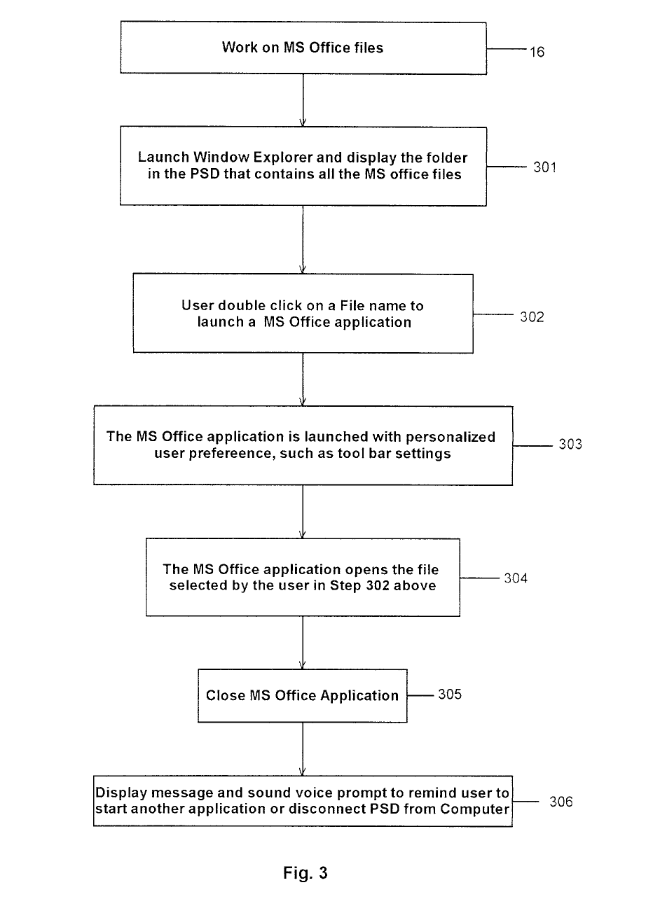

FIG. 3 depicts the process of launching MS office applications with personalized configurations. Once the user selects “Work on MS Office Files” in step 16, Windows Explorer is launched to display the folder in the PSD that contains all the MS Office files (step 301). In step 302, the user double clicks on a file name in order to launch the associated MS Office application. The MS office application is launched with personalized user preferences, such as tool bar settings, default fonts, custom macros, custom templates, and so forth (step 303). In step 304, the file that user want to open is opened by the application. After the user finishes his or her work, the MS office application is closed in step 305. Finally in step 306, a message is displayed with voice prompt to remind the user to start another application or to disconnect PSD from the computer.

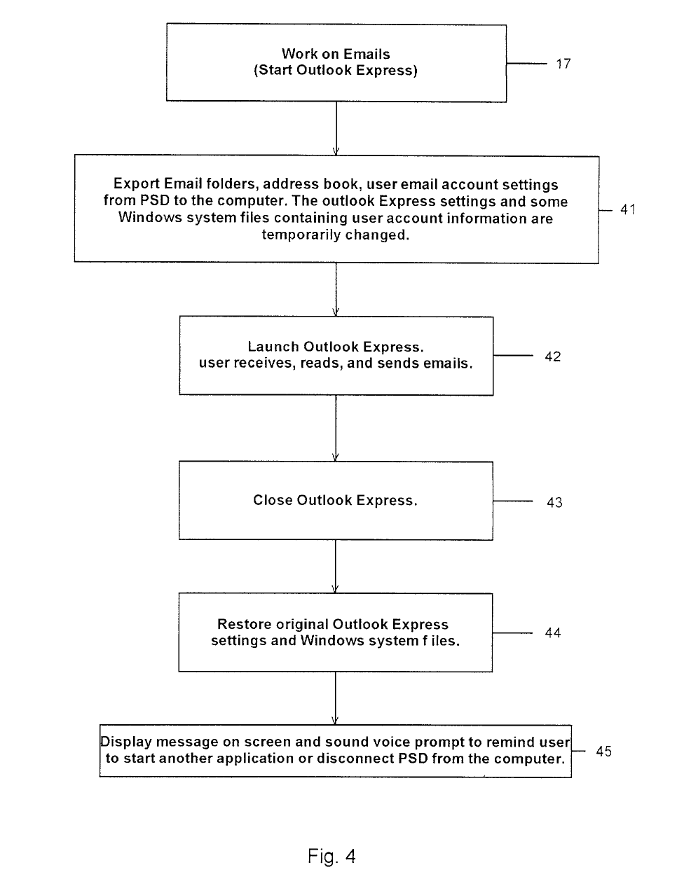

FIG. 4 depicts the process of launching Outlook Express with user's personalized information. This is usually done on a guest PC, such as publicly-accessible computer in an airport. Once the user selects “Work on Emails” in step 17, his/her email folders, personalized templates, address book, and user email account settings are exported from the PSD to the computer in step 41. Some Outlook Express settings and Windows system files in the PC, such as the one that contains user account information, may be temporarily changed in step 41. In step 42, Outlook Express is launched, temporarily configured with the user's personal settings, data, and files. The user can receive, read and send emails in an environment similar to the one in his/her everyday PC. Newly received or modified information is automatically stored in the PSD. After the user finishes working on emails, the Outlook Express is closed in step 43. The original setting of Outlook Express and any modified Windows system files in the PC are restored in step 44. In step 45, a message is displayed with voice prompt to remind user to start another application or to disconnect PSD from the computer.

The forgoing description describes one embodiment of the present invention. Other alternative constructions and instantiations of the present invention may suggest themselves to those skilled in the art. Therefore, the scope of the present invention is to be limited only by the claims below and equivalents thereof.

We claim:

1. A method of transporting user-specific settings and information from a first PC to a second PC, comprising
identifying, on the first PC, user-specific settings, configuration information, and data files associated with the operating environment and a suite of user selected PC applications,
storing the said user-specific settings, configuration information, and data files into a portable storage device, which can then be connected to a second PC,
making the said user-specific settings, configuration information, and data files stored in the said portable storage device accessible by the user from the said second PC so the user can use the said second PC in the same way as if he/she is using the first PC, with the user's operating environment and applications configured in a familiar and useful way for the user,
making the said portable storage device the default storage device while the said portable storage device is connected to the said second PC, so the information created, received and modified by the user is automatically stored into the said portable storage device, and
comparing, while the said portable storage device is connected to the said first PC, the user-specific settings, configuration information, and data files in the portable storage device with the user-selected settings, configuration information, and data files in the permanent storage device of the said first PC, and if a setting, configuration, or data file has been updated in one storage device, it will replace the older version of the information in the other storage device, and if a new piece of information is found in one storage device, it will be copied to the other storage device.

2. A method of transporting user-specific settings and information from a first PC to a second PC as recited in claim 1 wherein the user-specific settings include without limitation the cosmetic appearance of the operating environment, choice of cursor graphics, display settings, toolbar settings, menu layouts, and the other user-configurable features of the operating system employed on the PC.

3. A method of transporting user-specific settings, configuration information, and data files from a first PC to a second PC as recited in claim 1 wherein the user-specific settings and configuration information are the user-configurable features of Microsoft Office, including without limitation default fonts, custom macros, page layouts, templates, and where the data files include without limitation work-in-process word processing documents, spreadsheets, presentations, databases, and reports.

4. A method of transporting user-specific settings, configuration information, and data files from a first PC to a second PC as recited in claim 1 wherein the user-specific settings and configuration information include without limitation the user's email account information, such as STMP and POP server settings, passwords, address book, email signature and stationery, and where the user's data files include without limitation sent mail, received mail, deleted mail, outbox, attachments, and draft emails.

5. An apparatus for transporting user-specific settings, configuration information, and data files from a first PC to a second PC, comprising a portable storage device on which is stored an application program which
identifies, on the first PC, user-specific settings and information associated with the operating environment and with a suite of user selected PC applications,
stores the said user-specific settings, configuration information and data files into the portable storage device, which can then be connected to a second PC,
makes the said user-specific settings and information stored in the portable storage device accessible by the user of the said second PC so the user can use the said second PC in the same way as if he/she is using the first PC,
makes the said portable storage device the default storage device, while the said portable storage device is connected to the said second PC, so the information created, received and modified by the user is automatically stored into the said portable storage device, and
compares, while the said portable storage device is connected to the said first PC, the user-specific settings, configuration information, and data files in the portable storage device with the user-selected settings, configuration information, and data files in the permanent storage device of the said first PC and if a setting, configuration, or data file has been updated in one storage device, it will replace the older version of the information in the other storage device, and if a new piece of information is found in one storage device, it will be copied to the other storage device.

6. The Apparatus of claim 5 wherein the portable storage device is a flash memory storage device.

7. The Apparatus of claim 5 wherein the portable storage device is a flash memory storage device with USB interface.

8. The Apparatus of claim 5 wherein the portable storage device is a removable hard disk.

9. The Apparatus of claim 8 wherein the removable hard disk uses an USB interface.

10. The Apparatus of claim 5 wherein the user-specific information includes information related to the configuration and use of Microsoft Office applications.

11. The Apparatus of claim 10 wherein the portable storage device is a flash memory storage device.

12. The Apparatus of claim 10 wherein the portable storage device is a flash memory storage device with USB interface.

13. The Apparatus of claim 10 wherein the portable storage device is a removable hard disk.

14. The Apparatus of claim 13 wherein the removable hard disk uses USB interface.

15. The Apparatus of claim 5 wherein the user-specific settings and configuration information include without limitation the user's email account information, such as STMP and POP server settings, passwords, address book, email signature and stationery, and where the user's data files include without limitation sent mail, received mail, deleted mail, outbox, attachments, and draft emails.

16. The Apparatus of claim 15 wherein the portable storage device is a flash memory storage device.

17. The Apparatus of claim 15 wherein the portable storage device is a flash memory storage device with USB interface.

18. The Apparatus of claim 15 wherein the portable storage device is a removable hard disk.

19. The Apparatus of claim 18 wherein the removable hard disk uses USB interface.
